(19) United States
(12) Patent Application Publication
(10) Pub. No.: US 2014/0122057 A1
(43) Pub. Date: May 1, 2014

(54) TECHNIQUES FOR INPUT METHOD EDITOR LANGUAGE MODELS USING SPATIAL INPUT MODELS

(71) Applicant: Google Inc., (US)

(72) Inventors: Ciprian Ioan Chelba, Palo Alto, CA (US); Shumin Zhai, Los Altos, CA (US)

(73) Assignee: GOOGLE INC., Mountain View, CA (US)

(21) Appl. No.: 13/661,523

(22) Filed: Oct. 26, 2012

(51) Int. Cl. G06F 17/27; G06F 3/041

(52) U.S. Cl. 704/9

(57) ABSTRACT

A computer-implemented technique includes receiving, at a computing device including one or more processors, a touch input. The technique includes determining, at the computing device, one or more characters and one or more first probability scores using a spatial model and a position of the touch input with respect to a virtual keyboard displayable at the computing device, the one or more characters being from the virtual keyboard, the one or more first probability scores being associated with the one or more characters, respectively. The technique includes determining, at the computing device, a word based on the one or more characters and the one or more first probability scores using a language model. The technique also includes displaying, at the computing device, the word.

### FIELD

The present disclosure relates to input method editors for computing devices and, more particularly, to techniques for input method editor language models using spatial input models.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An input method editor (IME) may refer to a software application executable by a computing device. The IME can be configured to receive and process input to the computing device from a user. The user can provide the input at a user interface of the computing device. The user interface can include a physical keyboard and/or a touch display. For example, the touch display can be configured to display a virtual keyboard to the user and receive the input from the user.

### SUMMARY

A computer-implemented technique is presented. The technique can include receiving, at a computing device including one or more processors, a touch input. The technique can include determining, at the computing device, one or more characters and one or more first probability scores using a spatial model and a position of the touch input with respect to a virtual keyboard displayable at the computing device, the one or more characters being from the virtual keyboard, the one or more first probability scores being associated with the one or more characters, respectively. Determining the one or more characters and the one or more first probability scores can further include: (i) comparing first probability scores for a plurality of characters associated with the position of the touch input to a predetermined threshold, and (ii) eliminating any of the plurality of characters having an associated first probability score less than the predetermined threshold. The technique can include determining, at the computing device, a word based on the one or more characters and the one or more first probability scores using a language model by: (i) determining a plurality of words and a plurality of second probability scores using the language model based on the one or more characters and the one or more first probability scores determined using the spatial model, the plurality of second probability scores being associated with the plurality of words, respectively, and (ii) selecting the word from the plurality of words based on the plurality of second probability scores. The technique can also include displaying, at the computing device, the word.

Another computer-implemented technique is also presented. The technique can include receiving, at a computing device including one or more processors, a touch input. The technique can include determining, at the computing device, one or more characters and one or more first probability scores using a spatial model and a position of the touch input with respect to a virtual keyboard displayable at the computing device, the one or more characters being from the virtual keyboard, the one or more first probability scores being associated with the one or more characters, respectively. The technique can include determining, at the computing device, a word based on the one or more characters and the one or more first probability scores using a language model. The technique can also include displaying, at the computing device, the word.

In some embodiments, determining the one or more characters and the one or more first probability scores includes comparing first probability scores for a plurality of characters associated with the position of the touch input to a predetermined threshold.

In other embodiments, determining the one or more characters and the one or more first probability scores further includes eliminating any of the plurality of characters having an associated first probability score less than the predetermined threshold.

In some embodiments, the spatial model includes a two-dimensional Gaussian distribution of first probability scores centered at and associated with each character of the virtual keyboard.

In other embodiments, determining the word based on the one or more characters and the one or more first probability scores using the language model includes: determining a plurality of words and a plurality of second probability scores using the language model based on the one or more characters and the one or more first probability scores determined using the spatial model, the plurality of second probability scores being associated with the plurality of words, respectively, and selecting the word from the plurality of words based on the plurality of second probability scores.

In some embodiments, selecting the word from the plurality of words based on the plurality of second probability scores includes selecting one of the plurality of words having a highest relative second probability score.

In other embodiments, determining the plurality of words and the plurality of second probability scores is further based on at least one of word frequency statistics and a context of one or more other characters input to the computing device.

In some embodiments, the touch input is received from a user of the computing device.

In other embodiments, the touch input is a simulated touch input.

In some embodiments, the simulated touch input is generated at the computing device or received from another computing device via a network.

A computing device is also presented. The computing device can include a touch display and one or more processors. The touch display can be configured to receive a touch input. The one or more processors can be configured to determine one or more characters and one or more first probability scores using a spatial model and a position of the touch input with respect to a virtual keyboard displayable at the touch display, the one or more characters being from the virtual keyboard, the one or more first probability scores being associated with the one or more characters, respectively. The one or more processors can also be configured to determine a word based on the one or more characters and the one or more first probability scores using a language model. The touch display can also be configured to display the word.

In some embodiments, the one or more processors are configured to determine the one or more characters and the one or more first probability scores by comparing first probability scores for a plurality of characters associated with the position of the touch input to a predetermined threshold.

In other embodiments, the one or more processors are further configured to determine the one or more characters and the one or more first probability scores by eliminating any of the plurality of characters having an associated first probability score less than the predetermined threshold.

In some embodiments, the spatial model includes a two-dimensional Gaussian distribution of first probability scores centered at and associated with each character of the virtual keyboard.

In other embodiments, the one or more processors are configured to determine the word based on the one or more characters and the one or more first probability scores using the language model by: determining a plurality of words and a plurality of second probability scores using the language model based on the one or more characters and the one or more first probability scores determined using the spatial model, the plurality of second probability scores being associated with the plurality of words, respectively, and selecting the word from the plurality of words based on the plurality of second probability scores.

In some embodiments, selecting the word from the plurality of words based on the plurality of second probability scores includes selecting one of the plurality of words having a highest relative second probability score.

In other embodiments, the one or more processors are configured to determine the plurality of words and the plurality of second probability scores further based on at least one of word frequency statistics and a context of one or more other characters input to the computing device.

In some embodiments, the touch display is configured to receive the touch input from a user of the computing device.

In other embodiments, the touch display is configured to receive the touch input as a simulated touch input, wherein the simulated touch input is generated at the computing device or received from another computing device via a network.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram illustrating a computing network including an example computing device according to some implementations of the present disclosure;

FIG. 2 is a diagram illustrating a touch input by a user to the example computing device of FIG. 1;

FIG. 3 is diagram illustrating a virtual keyboard displayed at a touch display of the example computing device of FIG. 1;

FIG. 4 is a functional block diagram of the example computing device of FIG. 1;

FIG. 5 is a functional block diagram of an input method editor (IME) control module of the example computing device of FIG. 1; and

FIG. 6 is a flow diagram illustrating an example technique for an IME language model using a spatial input model according to some implementations of the present disclosure.

### DETAILED DESCRIPTION

An input method editor (IME) can include one or more language models configured to predict identities of words being input by the user, thereby allowing the user to provide faster input. Each language model can include a plurality of words and a corresponding probability for each word. The probabilities can be based on word frequency statistics and/or context of previous word(s). The IME can train the one or more language models based on habits or tendencies of the user.

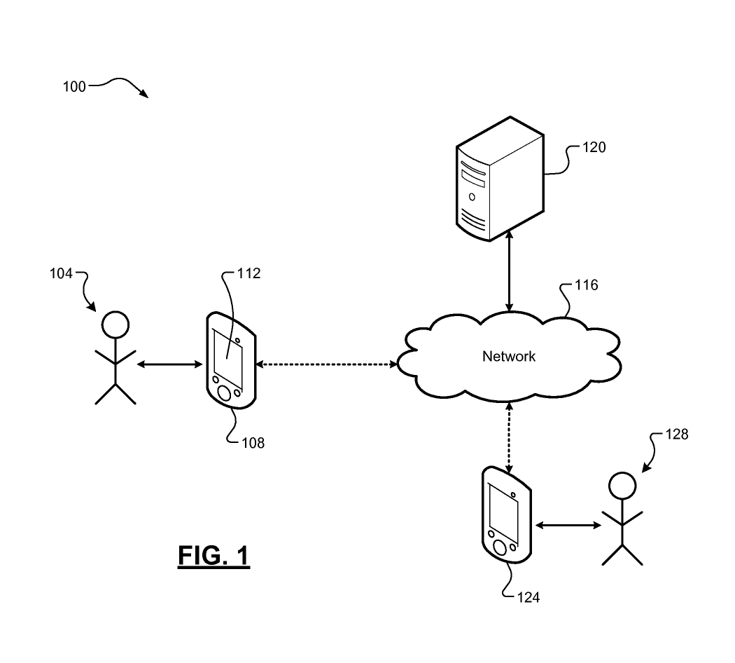

Referring now to FIG. 1, a computing network 100 is illustrated. A user 104 can interact with a computing device 108 according to some implementations of the present disclosure. The computing device 108 can be any suitable computing device having a touch display 112. The computing device 108 can also include one or more processors, memory, a transceiver, and any other suitable components. For example, the computing device 108 could be a desktop computer, a laptop computer, a tablet computer, or a mobile phone. The touch display 112 can be configured to display information to and receive input from the user 104. For example, the touch display 112 can be configured to display a virtual keyboard and receive characters via the virtual keyboard.

The computing device 108 can also be configured to communicate with other devices via a network 116. The network 116 can include a local area network (LAN), a wide area network (WAN), e.g., the Internet, or a combination thereof. The network 116 can also include other networks such as a public switched telephone network (PSTN) or a satellite network. For example, a server 120 can be configured to communicate with the computing device 108 via the network 116. The server 120 could be a web server or any other suitable server. It should be appreciated that while one server is shown, two or more servers could be implemented operating in a parallel or distributed architecture. The computing device 108 could also communicate with another computing device 124. For example, the other computing device 124 could be a personal computing device associated with another user 128, with whom the user 104 is also associated.

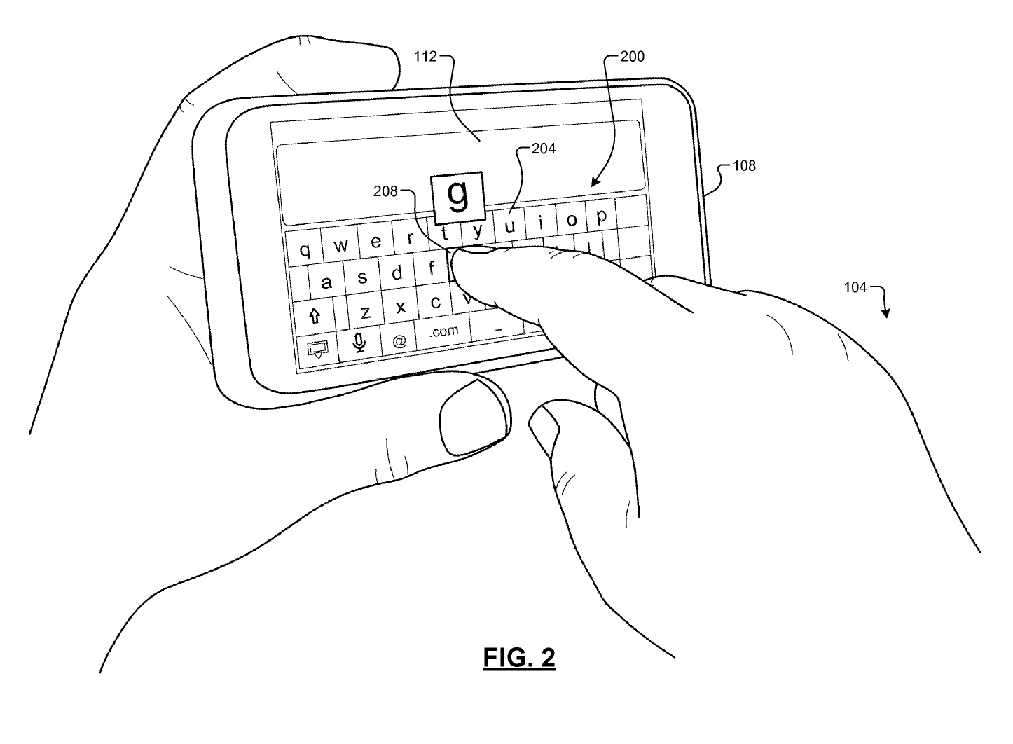

Referring now to FIG. 2, the touch display 112 can be configured to display a virtual keyboard 200 to the user 104. The virtual keyboard 200 can be a partial QWERTY virtual keyboard (as shown) or any other suitable keyboard configuration. The touch display 112 can also be configured to receive input from the user 104 indicating one or more characters 204 of the virtual keyboard 200. More specifically, the user 104 can provide a touch input 208 at one or more positions with respect to the virtual keyboard 200. The computing device 108 can then interpret the one or more positions of the touch input 208 to determine the one or more characters 204. For example, as shown in FIG. 2, the touch input 208 is determined to be the character “g”.

As previously mentioned, the computing device 108 can execute a software application referred to as an input method editor (IME). The IME can command the touch display 112 to display the virtual keyboard 200. The IME can also interpret the touch input 208 from the user 104 to determine the one or more characters. The one or more characters 204 can then be used to form words, which can be transmitted as part of text messages, e-mails, search queries, etc. The IME can also predict a word being input by the user 104 to assist the user 104 in providing faster input. For example, the IME can predict input words using a language model. The language model can include a plurality of words and associated probabilities based on word frequency statistics and/or context of previously input words.

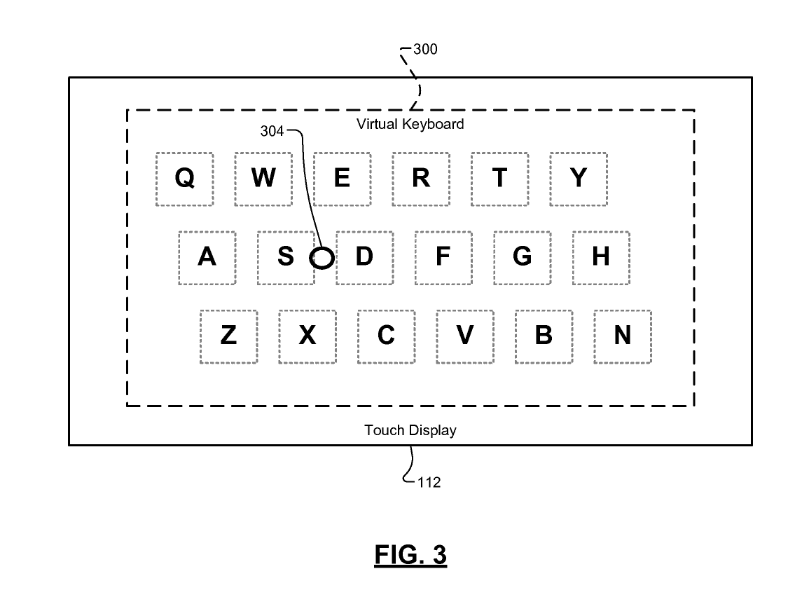

Referring now to FIG. 3, a virtual keyboard 300 displayed by the touch display 112 is illustrated. While the virtual keyboard 300 is a partial QWERTY virtual keyboard, it should be appreciated that other keyboard configurations can be used, such as a full QWERTY virtual keyboard. A touch input 304, e.g., from the user 104, is also illustrated. As shown, the touch input 304 is located between characters “s” and “d” of the virtual keyboard 300. The touch input 304 can occur in between characters of the virtual keyboard 300 because the touch display 112 has a generally flat surface with no physical keys. For example only, the user 104 could provide the touch input 304 in between characters of the virtual keyboard 300 due to an unexpected vibration of the computing device 108, due to a visual impairment of the user 104, due to an abnormal viewing angle of the touch display 112, or merely due to an unintended mistake.

The IME executing on the computing device 108, therefore, can determine which of the characters, e.g., “s” or “d”, was intended by the touch input 304. The IME can use a spatial model (also referred to as a spatial input model) to determine a most probable character associated with the touch input 304. For example, the most probable character may be a character having a center nearest to a location of the touch input 304. Each character can have an associated center position and an associated region centered at the center position, e.g., a square region representing a key of the virtual keyboard 300. After determining the character intended by the touch input 304, the IME can then predict the word being input by the user 104 using the language model. In other words, the IME can input the determined character into the language model. The language model can then generate one or more potential words and associated probabilities. For example, the IME could automatically select the most probable potential word.

The most probable character, however, may not have been the character intended by the touch input 304 of the user 104. More specifically, if the spatial model is used to determine that the more probable character is “s” instead of “d”, the language model receives “s” in order to perform word prediction. The letter “s”, however, may not fit in the context of one or more other characters input by the user 104. For example, the predicted input could be “to so”, but the user 104 intended to input “to do”. Alternatively, for example, the predicted input could be “my boat is socked”, but the user 104 intended to input “my boat is docked”. In these cases, the language model may incorrectly predict the word(s) being input by the user 104, thereby causing the user 104 to have to delete the characters and attempt to input the characters again.

Accordingly, techniques are presented for IME language models using spatial input models. The techniques generally provide for more accurate IME language models, which can more accurately predict user input and thereby create an improved user experience. Specifically, the one or more characters and associated probabilities determined by the spatial model can be used as an input to the IME language model. In other words, the techniques do not perform an initial determination of a character intended by a touch input, and instead provide the one or more potential characters associated with the touch input and their corresponding probabilities for use by the IME language model. The IME language model can then use this information for more accurate prediction of the word being input by a user.

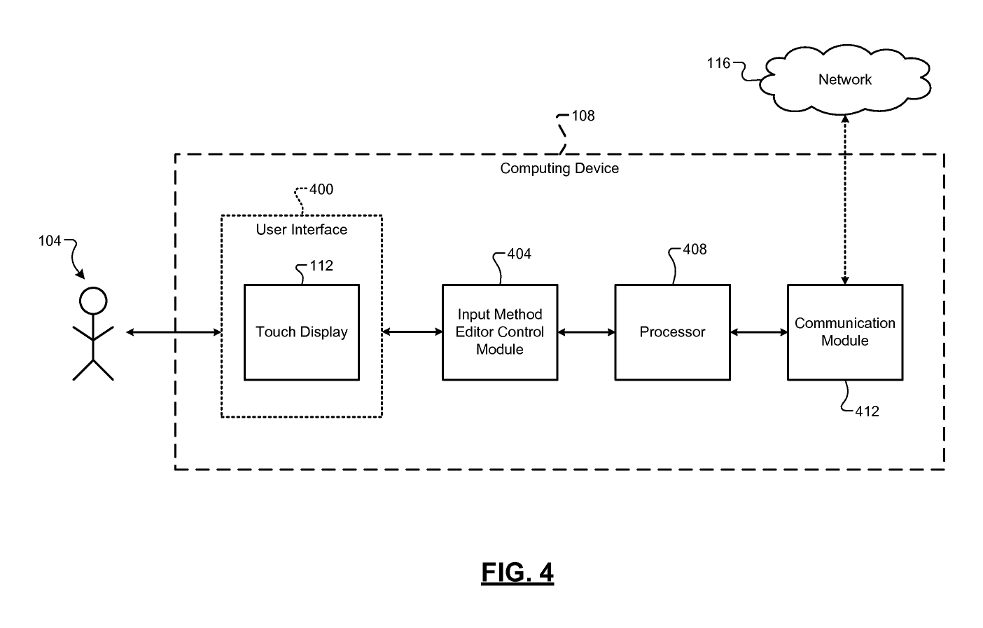

Referring now to FIG. 4, an example of the computing device 108 according to some implementations of the present disclosure is illustrated. The computing device 108 can include a user interface 400, an IME control module 404, a processor 408, and a communication module 412. The computing device 108 can also include other components, such as memory. It should be appreciated that the term “processor” as used herein can refer to two or more processors operating in a parallel or distributed architecture. Additionally, it should be appreciated that the processor 408 can wholly or partially execute the modules of the computing device 108.

The user interface 400 can control communication between the computing device 108 and the user 104. More specifically, the user interface 400 can display information to and receive input from the user 104. The user interface 400 can include the touch display 112. While the user interface 400 is shown to only include the touch display 112, it should be appreciated that the user interface 400 can include other components such as physical keys or buttons, a speaker, a microphone, a camera, and/or vibrator. The touch display 112 of the user interface 400 can receive a touch input from and display a predicted word to the user 104. The touch input can include a spot input, a slide input, or a combination thereof. A spot input refers to an input at a singular location, which is typically a spot associated with a stylus or a finger of the user 104. A slide input refers to a spot input that is then dragged across the touch display 112, during which the user 104 maintains contact with the touch display 112. For example, slide input could be used to input more than one character in a single motion.

The IME control module 404 can control the user interface 400. More particularly, the IME control module 404 can control information displayed at and process, e.g., using the processor 408, input received at the touch display 112. For example, the information displayed at the touch display 112 can include a virtual keyboard. It should be appreciated that the information displayed at the touch display 112 can also include icons, menus, and/or software application interfaces. The input received at the touch display 112, e.g., from the user 104, can include one or more touch inputs. The IME control module 404 can then determine a position for each touch input, e.g., with respect to the virtual keyboard. The IME control module 404 can determine one or more characters and one or more first probability scores using a spatial model and the position of the touch input. As described more fully below, the spatial model can be used to generate the one or more first probability scores, which can be associated with the one or more characters, respectively.

After determining the one or more characters and the associated one or more first probability scores, the IME control module 404 can determine a word based on the one or more characters and the one or more first probability scores using a language model. The language model can be used to generate the word using the one or more characters and the associated one or more first probability scores as an input or a parameter. For example, and as described more fully below, the language model can be used to generate one or more potential words and one or more second probability scores, respectively. The second probability score(s) are generated using the language model, and are based on the first probability score(s) generated using the spatial model. The IME control module 404 can then display the word at the touch display 112. For example only, a potential word having a highest relative second probability score may be selected and displayed at the touch display 112.

The processor 408 can control operation of the computing device 108. For example, the processor 408 can load and execute an operating system of the computing device 108. The processor 408 can also execute software applications. Further, the processor 408 can also wholly or partially execute the IME control module 404 and/or the communication module 412. The communication module 412 controls communication between the computing device 108 and other devices. Specifically, the communication module 412 can transmit and/or receive information to other devices, e.g., servers, via the network 116. For example, the communication module 412 can include a transceiver (not shown). It should be appreciated that the communication module 412 can also be configured for communication via other mediums, e.g., radio frequency communication and/or near field communication (NFC).

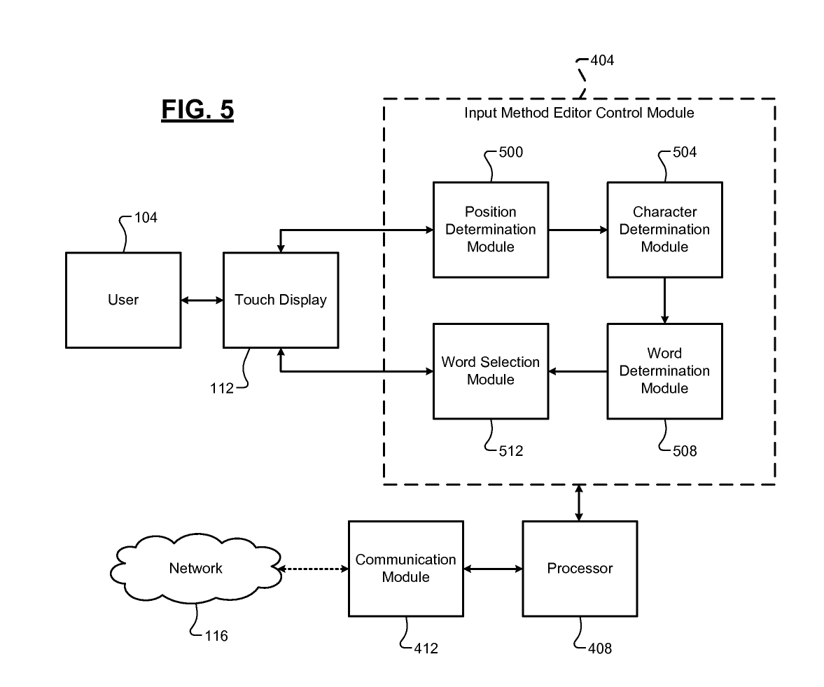

Referring now to FIG. 5, an example of the IME control module 404 is illustrated. The IME control module 404 can include a position determination module 500, a character determination module 504, a word determination module 508, and a word selection module 512. It should be appreciated that the IME control module 404 can also include other components, such as memory. Additionally, as previously described, the various modules of the IME control module 404 can be executed wholly or partially by the processor 408.

The position determination module 500 can receive the touch input at the touch display 112. The position determination module 500 can determine a position of the touch input with respect to the touch display 112. For example, the position could be a position with respect to the virtual keyboard displayed at the touch display 112. The touch input can be from the user 104. Alternatively, the touch input could be a simulated touch input. In other words, the position determination module 500 can receive data indicating a position with respect to the touch display 112. It should be appreciated that the term “simulated touch input” as used herein can refer to any suitable data representative of touch input, such as “sampled touch input.”

The simulated touch input can be used to train the language model. More specifically, for each simulated touch input, one or more characters and one or more first probability scores can be determined and used to train or adapt the language model. The simulated touch input could be generated at the computing device 108. This can be referred to as local or off-line training of the language model. The simulated touch input could also be received from another device, e.g., server 120, via the network 116. This can be referred to as on-line training of the language model. Specifically, the simulated touch input could be received from the other device, e.g., server 120, on the network 116 via the communication module 412 and the processor 408.

The character determination module 504 can receive the position of the touch input at the touch display 112 from the position determination module 500. The character determination module 504 can determine one or more characters associated with the position of the touch input. The one or more characters can be from the virtual keyboard. Specifically, the character determination module 504 can use the spatial model to determine the one or more characters and one or more first probability scores associated with the one or more characters, respectively. The first probability score can indicate a likelihood that a specific character was intended to be selected by the touch input. For example, the spatial model can be used to generate a plurality of characters and an associated plurality of first probability scores.

As previously described, the spatial model can include a two-dimensional Gaussian distribution of first probability scores for each character of the virtual keyboard, e.g., for varying x-y coordinates of the touch display 112. It should be appreciated that other distributions of first probability scores could also be used, such as an adapted or normalized distribution based on past activity of the user 104. The character determination module 504 could then select a subset of the plurality of characters based on their first probability scores to obtain the one or more characters. For example, the character determination module 504 could select any characters of the plurality of characters having first probability scores greater than a predetermined first probability threshold. The predetermined first probability threshold could indicate a desired level of confidence that the touch input was intended to select a specific character, e.g., greater than 25%.

The word determination module 508 can receive the one or more characters and the associated one or more first probability scores from the character determination module 504. The word determination module 508 can determine one or more potential words and one or more second probability scores for the one or more potential words, respectively. The word determination module 508 can determine the one or more potential words and the associated one or more second probability scores using the one or more characters, the one or more associated first probability scores, and the language model. As previously mentioned, the second probability score(s) are generated using the language model, and are based on the first probability score(s) generated using the spatial model. In other words, the one or more characters and the one or more associated first probability scores can be used as an input or a parameter for the language model.

Other inputs to the language model can include word frequency statistics and context of words previously input at the computing device 108. The word frequency statistics can be built into the language model, e.g., previously trained using a corpus. Instead of a corpus, the language model could also be built using a combination of text-based applications at the computing device. For example, the language model could be built using e-mail, text messaging, and social network activity. For example only, the first probability scores of the language model could be built based on 50% e-mail activity, 25% text-messaging activity, and 25% social network activity. The words previously input at the computing device 108, however, are consistently changing during usage of the computing device 108. The language model generally can include a plurality of words and a plurality of second probability scores for the plurality of words, respectively. The word determination module 508 can use the language model to predict one or more words after each touch input (and further based on context of previously input words, if any).

As previously mentioned, the word determination module 508 can use the one or more characters and the associated one or more first probability scores as an input to the language model. For example only, the one or more characters could include a first character having a first probability score of 51% and a second character having a first probability score of 49%. Instead of determining the touch input to be the first character, and then predicting one or more words using the first character, the language model can effectively weigh the first probability scores of each of the one or more characters in order to more accurately predict the one or more words. In the example above, the language model may predict the one or more words using the second character because the second character was also very likely intended to be selected by the touch input and the second character may be a better fit for the language model, e.g., in the context of previously input words.

In another example, however, the first character could have a first probability score of 99% and the second character could have a first probability score of 1%. In this example, the language model could weigh the first probability scores and could more likely determine that the first character was intended to be selected by the touch input and could therefore predict the one or more words using the first character. Prediction of one or more words after each touch input can include using the language model to determine one or more words and associated one or more second probability scores. A subset of the plurality of words can be selected based on their associated second probability scores to obtain the one or more words. For example, the one or more words can be one or more words of the plurality of words having associated second probability scores greater than a predetermined second probability threshold. The predetermined second probability threshold can indicate a desired level of confidence that input currently received at the computing device is intended to be a specific word.

The word selection module 512 can receive the one or more words and the associated one or more second probability scores from the word determination module 508. The word selection module 512 can select one of the one or more words to obtain a selected word. The word selection module 512 can then provide the selected word for display at the touch display 112. The word selection module 512 can automatically select one or the one or more words based on the associated one or more second probability scores to obtain the selected word. In this manner, the word selection module 512 can predict the selected word. Alternatively, the word selection module 512 could provide the one or more words and the associated one or more second probability scores for display at the touch display 112. The word selection module 512 could then receive a selection, e.g., from the user 104, of one of the one or more words to obtain the selected word.

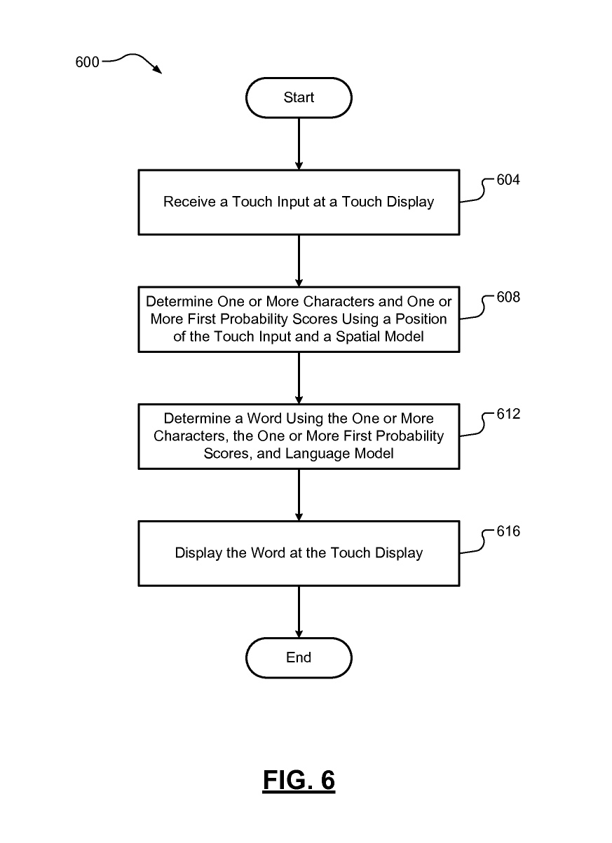

Referring now to FIG. 6, an example technique 600 for IME language models using spatial input models is illustrated. The technique 600 begins at 604. At 604, the touch display 112 receives a touch input. For example, the touch input could be from the user 104 or the touch input could be a simulated touch input generated at the computing device 108 or at a remote server. At 608, the IME control module 404 determines one or more characters and one or more first probability scores using a spatial model and a position of the touch input with respect to a virtual keyboard displayable at the computing device 108. The one or more characters can be from the virtual keyboard. The one or more first probability scores can be associated with the one or more characters, respectively. At 612, the IME control module 404 can determine a word based on the one or more characters and the one or more first probability scores using a language model. At 616, the touch display 112 can display the word. The technique 600 can then end or return to 604 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device including one or more processors, a touch input;
determining, at the computing device, one or more characters and one or more first probability scores using a spatial model and a position of the touch input with respect to a virtual keyboard displayable at the computing device, the one or more characters being from the virtual keyboard, the one or more first probability scores being associated with the one or more characters, respectively, wherein determining the one or more characters and the one or more first probability scores further includes:
(i) comparing first probability scores for a plurality of characters associated with the position of the touch input to a predetermined threshold, and
(ii) eliminating any of the plurality of characters having an associated first probability score less than the predetermined threshold;
determining, at the computing device, a word based on the one or more characters and the one or more first probability scores using a language model by:
(i) determining a plurality of words and a plurality of second probability scores using the language model based on the one or more characters and the one or more first probability scores determined using the spatial model, the plurality of second probability scores being associated with the plurality of words, respectively, and
(ii) selecting the word from the plurality of words based on the plurality of second probability scores; and
displaying, at the computing device, the word.

2. A computer-implemented method, comprising:
receiving, at a computing device including one or more processors, a touch input;
determining, at the computing device, one or more characters and one or more first probability scores using a spatial model and a position of the touch input with respect to a virtual keyboard displayable at the computing device, the one or more characters being from the virtual keyboard, the one or more first probability scores being associated with the one or more characters, respectively;
determining, at the computing device, a word based on the one or more characters and the one or more first probability scores using a language model; and
displaying, at the computing device, the word.

3. The computer-implemented method of claim 2, wherein determining the one or more characters and the one or more first probability scores includes comparing first probability scores for a plurality of characters associated with the position of the touch input to a predetermined threshold.

4. The computer-implemented method of claim 3, wherein determining the one or more characters and the one or more first probability scores further includes eliminating any of the plurality of characters having an associated first probability score less than the predetermined threshold.

5. The computer-implemented method of claim 2, wherein the spatial model includes a two-dimensional Gaussian distribution of first probability scores centered at and associated with each character of the virtual keyboard.

6. The computer-implemented method of claim 2, wherein determining the word based on the one or more characters and the one or more first probability scores using the language model includes:
determining a plurality of words and a plurality of second probability scores using the language model based on the one or more characters and the one or more first probability scores determined using the spatial model, the plurality of second probability scores being associated with the plurality of words, respectively, and
selecting the word from the plurality of words based on the plurality of second probability scores.

7. The computer-implemented method of claim 6, wherein selecting the word from the plurality of words based on the plurality of second probability scores includes selecting one of the plurality of words having a highest relative second probability score.

8. The computer-implemented method of claim 6, wherein determining the plurality of words and the plurality of second probability scores is further based on at least one of word frequency statistics and a context of one or more other characters input to the computing device.

9. The computer-implemented method of claim 2, wherein the touch input is received from a user of the computing device.

10. The computer-implemented method of claim 2, wherein the touch input is a simulated touch input.

11. The computer-implemented method of claim 10, wherein the simulated touch input is generated at the computing device or received from another computing device via a network.

12. A computing device, comprising:
a touch display configured to receive a touch input; and
one or more processors configured to:
determine one or more characters and one or more first probability scores using a spatial model and a position of the touch input with respect to a virtual keyboard displayable at the touch display, the one or more characters being from the virtual keyboard, the one or more first probability scores being associated with the one or more characters, respectively, and
determine a word based on the one or more characters and the one or more first probability scores using a language model,
wherein the touch display is further configured to display the word.

13. The computing device of claim 12, wherein the one or more processors are configured to determine the one or more characters and the one or more first probability scores by comparing first probability scores for a plurality of characters associated with the position of the touch input to a predetermined threshold.

14. The computing device of claim 13, wherein the one or more processors are further configured to determine the one or more characters and the one or more first probability scores by eliminating any of the plurality of characters having an associated first probability score less than the predetermined threshold.

15. The computing device of claim 12, wherein the spatial model includes a two-dimensional Gaussian distribution of first probability scores centered at and associated with each character of the virtual keyboard.

16. The computing device of claim 12, wherein the one or more processors are configured to determine the word based on the one or more characters and the one or more first probability scores using the language model by:
determining a plurality of words and a plurality of second probability scores using the language model based on the one or more characters and the one or more first probability scores determined using the spatial model, the plurality of second probability scores being associated with the plurality of words, respectively, and
selecting the word from the plurality of words based on the plurality of second probability scores.

17. The computing device of claim 16, wherein selecting the word from the plurality of words based on the plurality of second probability scores includes selecting one of the plurality of words having a highest relative second probability score.

18. The computing device of claim 16, wherein the one or more processors are configured to determine the plurality of words and the plurality of second probability scores further based on at least one of word frequency statistics and a context of one or more other characters input to the computing device.

19. The computing device of claim 12, wherein the touch display is configured to receive the touch input from a user of the computing device.

20. The computing device of claim 12, wherein the touch display is configured to receive the touch input as a simulated touch input, wherein the simulated touch input is generated at the computing device or received from another computing device via a network.
